(19) United States
(12) Patent Application Publication
(10) Pub. No.: US 2026/0257397 A1
(43) Pub. Date: Sep. 3, 2026

(54) Insulation for Structural Insulated Panels

(71) Applicant: Verdant Building Products, Berkeley, CA (US)

(72) Inventor: Anthony Dente, Berkeley, CA (US)

(73) Assignee: Verdant Building Products, Berkeley, CA (US)

(21) Appl. No.: 19/652,620

(22) Filed: Apr. 20, 2026

Related U.S. Application Data
(63) Continuation-in-part of application No. 19/363,024, filed on Oct. 20, 2025.
Application No. 19/363,024 is a continuation-in-part of application No. 18/447,487, filed on Aug. 10, 2023, now Pat. No. 12,460,414.

(51) Int. Cl. B27N 3/04; B27N 3/12

(52) U.S. Cl. CPC B27N 3/04; B27N 3/12

(57) ABSTRACT

An insulative panel having a width,, a length and a thickness is composed of plant matter chopped into pieces having a specific size range; and a binder holding the chopped pieces together in a rigid, semi-rigid or flexible mass.

### CROSS-REFERENCE TO RELATED APPLICATIONS

The instant application is a continuation-in-part (CIP) of co-pending application S/N 19/363,024, filed 10/20/25, which is a CIP of S/N 18/447,487 filed 08/10/2023. All disclosure of the parent applications is incorporated herein at least by reference.

### BACKGROUND OF THE INVENTION

### 1. Field of the Invention

The present invention is in the technical field of modular prefabricated structural components and relates more particularly to structural insulated panels (SIPS), and to insulative materials and binders.

### 2. Description of Related Art

Modular and prefabricated components for use in developing structures for residences and commercial buildings are notoriously well known in the art. In a particular circumstance, insulated panels, such as prefabricated panels insulated with polymer foam of various sorts, are well known and are referred to as F-SIPS. It is also well known that creation and production of the polymer insulating materials for F-SIPS is not carbon neutral. It is desirable in the present circumstance of global warming to reduce carbon emissions to a minimum, and a significant quantity of carbon is released into the atmosphere in the thermal and chemical procedures producing polymer foam.

What is clearly needed in the art is apparatus and process for providing insulation that does not release carbon into the atmosphere and even sequesters it. Plants capture carbon through photosynthesis and straw is a proven plant-based insulation material as it is produced in harvesting crops that bind carbon. Straw-insulated structural panels, termed hereafter S-SIPS, and insulative products comprising straw, and procedures of growing additional straw crops and processing same into insulation for insulative products and for prefabricated structural panels can make a significant difference in carbon emissions.

A well-known issue in insulating structural panels is in preparing the insulative material and how binding may be done.

### BRIEF SUMMARY OF THE INVENTION

In an embodiment of the invention an insulative panel having a width, a length and a thickness is provided, comprising plant matter chopped into pieces having a specific size range and a binder holding the chopped pieces together in a rigid mass. In one embodiment the width is four feet, the length is eight feet and the thickness is one of 3 ½ inches, 5 ½ inches, 7 ¼ inches, or 9 ¼ inches. Also, in one embodiment the plant matter is one of or a mixture of wheat, rice, barley or oat straw, chopped into pieces from one eighth to 2 inches in length. In one embodiment the binder is one of nanocellulose, sugar, starch-based material or one or a mixture of natural waxes. In one embodiment the binder is a plant protein. And in one embodiment the protein is gluten.

In another aspect of the invention a method for making an insulative panel is provided, comprising providing a mold of a width, a length and a depth, filling the mold with a slurry of chopped straw mixed with a binder, allowing time for the binder to solidify, and removing the insulative panel from the mold.

In one embodiment the method further provides coating the mold with a release agent prior to the step of filling the mold. Also, in one embodiment the method comprises filling the mold with a slurry of chopped straw of one of or a mixture of wheat, rice, barley or oat straw, chopped into pieces from one eighth to 2 inches in length, mixed with gluten as the binder. And in one embodiment the method comprises mixing gluten with warm water to form the slurry, and adding a catalyst to the slurry, prior to filling the mold.

In one embodiment the method comprises selecting the catalyst as an enzyme, and in one embodiment selecting transglutaminase as the enzyme.

In yet another aspect of the invention a method of making insulative panels is provided comprising providing a closed conveyance with molds evenly spaced apart along the conveyance, indexing the conveyance intermittently a length of the spacing between molds on the conveyance, adding a measured amount of a slurry of chopped straw mixed with a binder to each mold stopped at a loading station, and removing insulative panels from molds stopped at an unloading station.

In one embodiment o the method further comprises leveling the slurry in molds stopped at a leveling station after the loading station. Also, in one embodiment the method further comprises, in the step for adding a measured amount of a slurry of chopped straw mixed with a binder, providing the chopped straw as one of or a mixture of wheat, rice, barley or oat straw, chopped into pieces from one eighth to 2 inches in length, mixed with gluten as the binder. Also, in one embodiment the method comprises mixing gluten with warm water and a catalyst, then adding chopped straw to form the slurry, prior to filling the mold. Also, in one embodiment the method comprises providing the catalyst as an enzyme. Also, in one embodiment the method comprises selecting transglutaminase as the enzyme. In one embodiment the method comprises providing heat or cooling to slurry loaded molds at one or more stations. And in one embodiment the method comprises coating empty molds with a release agent prior to the step of filling the molds with the slurry of chopped straw mixed with a binder.

### BRIEF DESCRIPTION OF THE SEVERAL VIEWS OF THE DRAWINGS

FIG. 1 is a perspective view of a straw insulated structural panel in an embodiment of the present invention.

FIG. 2A is a perspective view of a sturdy support plate supporting a frame for a building panel in an embodiment of the invention.

FIG. 2B illustrates the frame of FIG. 2A filled with chopped straw.

FIG. 2C illustrates a rectangular section of fabric hardware netting of the width and length of the frame of FIG. 2B.

FIG. 3A is a perspective view of a mold in an embodiment of the invention.

FIG. 3B is a perspective view of a ram to fit in the mold of FIG. 3A.

FIG. 4 is a perspective view of an insulative panel in an embodiment of the invention.

FIG. 5 is a mostly representative plan view of a conveyor process for making insulative panels in an embodiment of the invention.

FIG. 6 is a flow diagram illustrating the process shown in FIG. 5 in production of insulative panels in an embodiment of the invention.

### DETAILED DESCRIPTION OF THE INVENTION

An important object of the present invention is to provide building panels that minimize heat transfer across the panels and do so by incorporating insulative material in the panels that derive from plant material, which binds carbon. In embodiments of the present invention building panels are provided that limit heat transfer through the panels by features of construction of the panels, and also by incorporating insulative material that is straw from various sources, treated with a binder to old the straw together, as is needed to have panels that may be stored, shipped and manipulated in building procedures.

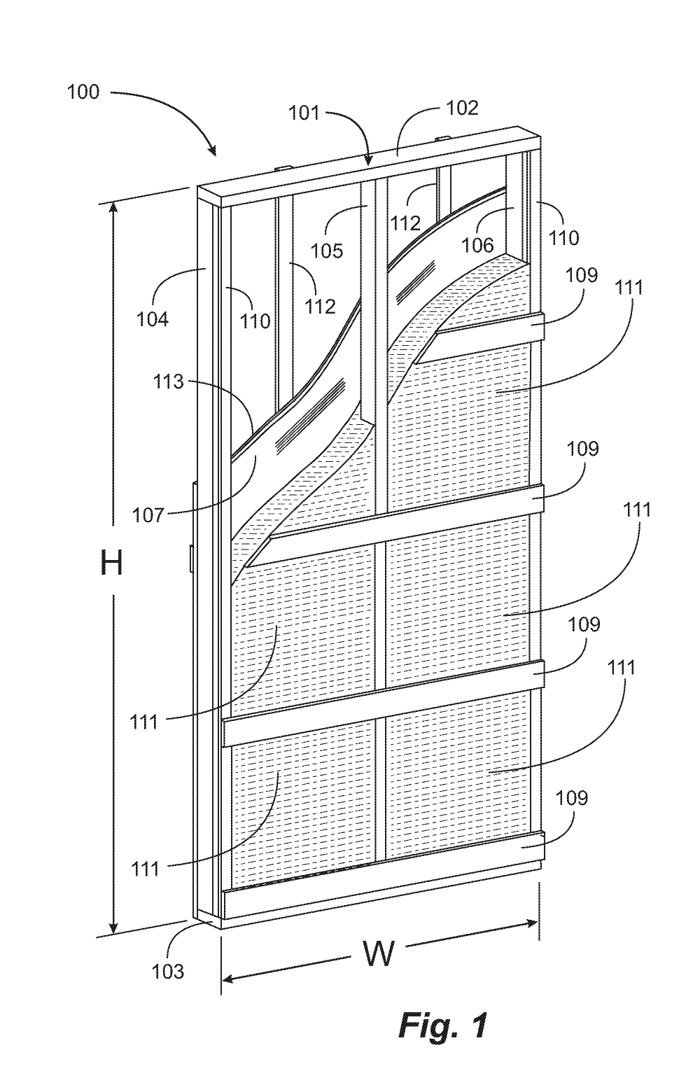

FIG. 1 is a perspective view of a straw insulated structural panel 100 in an embodiment of the present invention, from a viewpoint within a building, such that the front surface of the structure in FIG. 1 faces into the building and the back surface is to the outside. Panel 100 in this embodiment has a rectangular frame 101 that has a cap beam 102 and a base beam 103. In one embodiment the cap beam and the base beam are both 2 x 6 lumber, having a width of 5.5 inches. In alternative embodiments the cap beam and the base beam may be wider, such as 2 x 8, and in some embodiments may be other than lumber, such as a combination of wood pulp and synthetic materials covered with a synthetic shell, similar to decking materials. In one embodiment W is four feet and H is eight feet, and in another the dimensions are four by ten feet. The overall dimensions are determined in some cases by standard sizes for structural panels, but these dimensions are not limiting to the scope of the invention.

Frame 101 has, in this example, three vertical studs 104, 105 and 106 that, in this example, are 2 x 4 lumber, 3.5 inches in width. In other embodiments the studs may be other than lumber, such as a combination of wood pulp and synthetic materials covered with a synthetic shell, similar to decking materials. Studs 104 and 106 form partial outer edges of frame 101 and the rear edge of studs 104 and 106 are even with the rear edge of cap and base beams 102 and 103. Vertical stud 105, however, has an inner edge that is even with the forward edge of cap and base beams 102 and 103. The lesser depth of the three studs, and the staggering of the studs, minimizes thermal bridging through the structure. A vertical strip 110 is added along the forward edge of vertical studs 104 and 106 to even out the overall size of the building panel, and this strip does not contact the vertical studs.

Structural panel 100 has a structural sheathing panel 107 covering the rear of frame 101. The structural sheathing panel may be one-quarter, one half, or three quarters thickness plywood in alternative embodiments. In alternative embodiments the sheathing panel may be other than plywood, such as, for example, weatherboard or fiberboard. The sheathing panel has in some embodiments an additional weather barrier 113, preferably of a biodegradable material. Vertical strips of wood 112, in some embodiments 1 x 2 inch, is added on the back side to provide a rainscreen as a space between the sheathing and siding, allowing moisture to evaporate.

In this example a series of cross pieces 109, spanning the width of the building panel on the forward side, and spaced apart vertically, act as chase strips to provide space for electrical wiring. These strips may be 1 x 2 inch lumber, or in some cases 1 x 4.

The internal volumes of the building panel, for the full depth of the frame, are filled with an especially prepared straw material 111. Straw material 111 in one embodiment is prepared from dried straw that has been chopped in a chopping machine to individual strands that may vary between one-half inch to about 1 inch in length. The individual strands may vary within a predetermined range in length. The type of straw may vary. The original straw may be wheat, rice, barley or oat straw depending on a number of factors, such as, for example, availability and cost. In some embodiments a mixture of different types of straw may be used.

Although the panels described above have staggered studs, that is, the cap and base beams may be greater in depth than the studs, to minimize conductive heat transfer through the panel, in some embodiments the cap and base beams and the studs may be of equal depth.

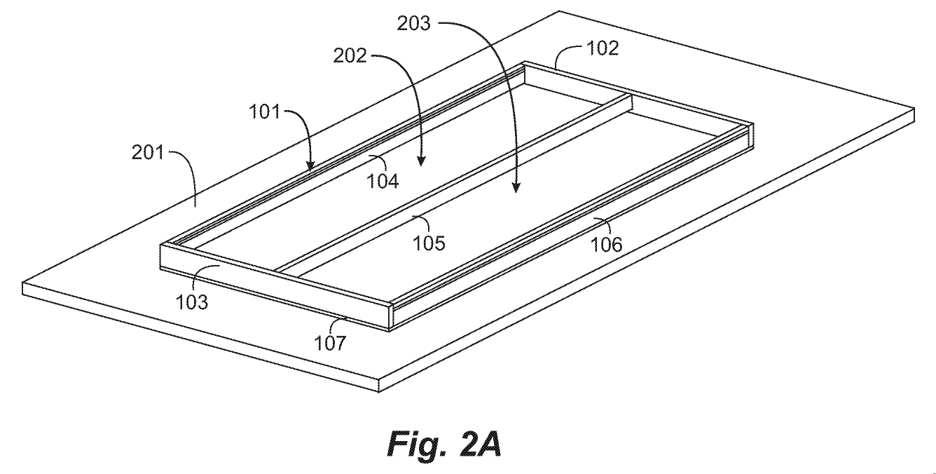

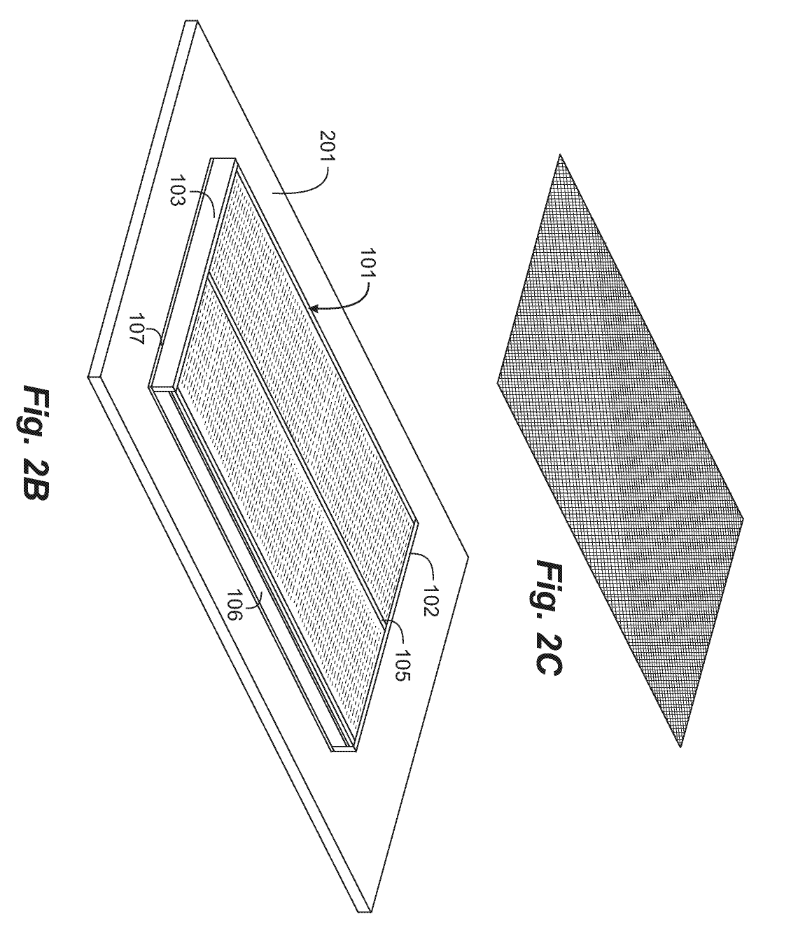

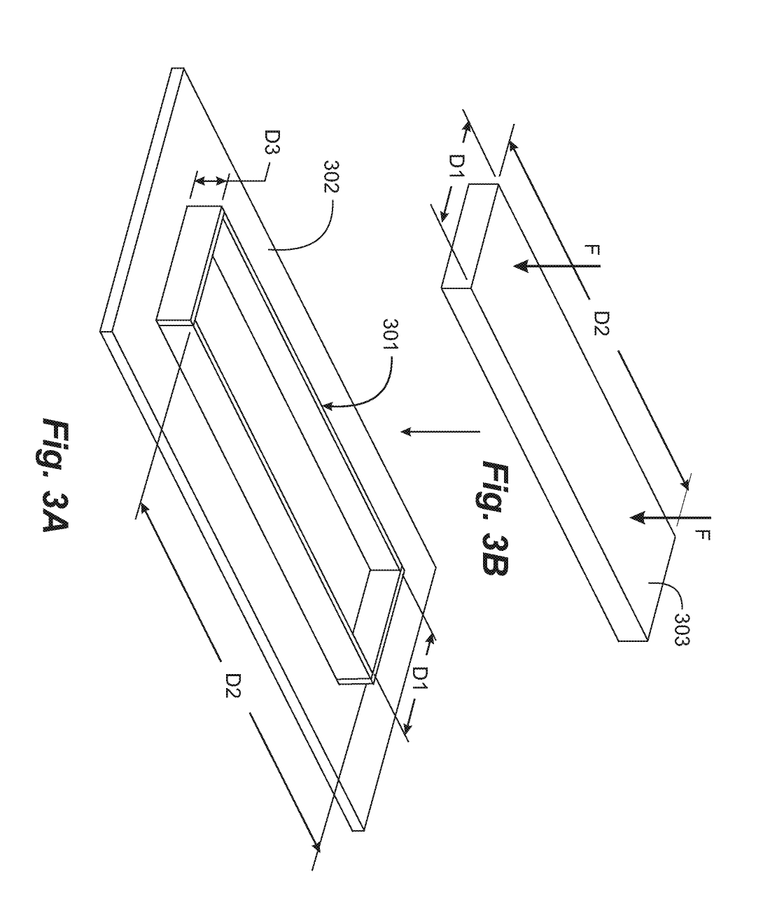

FIG. 2A is a perspective view of a sturdy support plate 201 supporting a frame 101 for a building panel in an embodiment of the invention. In FIG. 2A frame 101 has structural sheathing 107 attached, but not the rainscreen strips on the back or the chase strips on the front. In this circumstance frame 101 presents two side-by-side volumes 202 and 203 upward.

In one embodiment of a method to apply the insulation material into the open frame, dried straw is fed through the chopping machine and blown or poured after chopping into the side-by-side volumes of the panel frame. FIG. 2B illustrates frame 101 filled with chopped straw. FIG. 2C illustrates a rectangular section of a natural fiber fabric netting of the width and length of frame 101. In one embodiment after the frame volumes are filled with chopped straw, netting 204 is placed over the frame and stapled or nailed to the edges of the cap beam, base beam, and studs to retain the chopped straw in the frame. Once netting 204 is attached, the chase strips and rainscreen strips may also be attached, and the building panel is finished.

In an alternative method the chopped straw may be treated with an additive binder and formed into the volumes of the frame while the binder has yet to cure. In some embodiments the binder may be nanocellulose or sugar or starch-based material. Natural waxes may also be used as binders. After filling the frame the binder material may harden by a chemical or a physical process and cause the chopped straw to form a semi-solid form. In some cases the binder may be liquid at a temperature at application and may gel on cooling. There are a wide variety of materials that might be used as a binder. Some are polymeric. Other chemical fillers may be used as well. Naturally derived admixtures are preferably used. In some circumstances chopped straw with a binder may be used and a fabric netting or screen may be employed as well.

Straw might in some embodiments be long strand. In other embodiments the straw may be chopped to specific parameters that denote both a gradient and proportion of straw fiber sizes, for example from roughly 12” in length down to roughly 1/32 inches in length. The chopped straw may be cleaned to remove small straw particles by graded screening and by moving air over the straw to remove fines and dust. In some cases a binder may be heated before being added to straw particles, and in some processes the straw particles may be heated without a binder. In some processes industrial agricultural machinery may be used in the processing of straw.

An important feature of the processing a straw with or without a binder is to create a straw matrix with a microstructure that significantly improves upon the thermal performance of unprocessed straw.

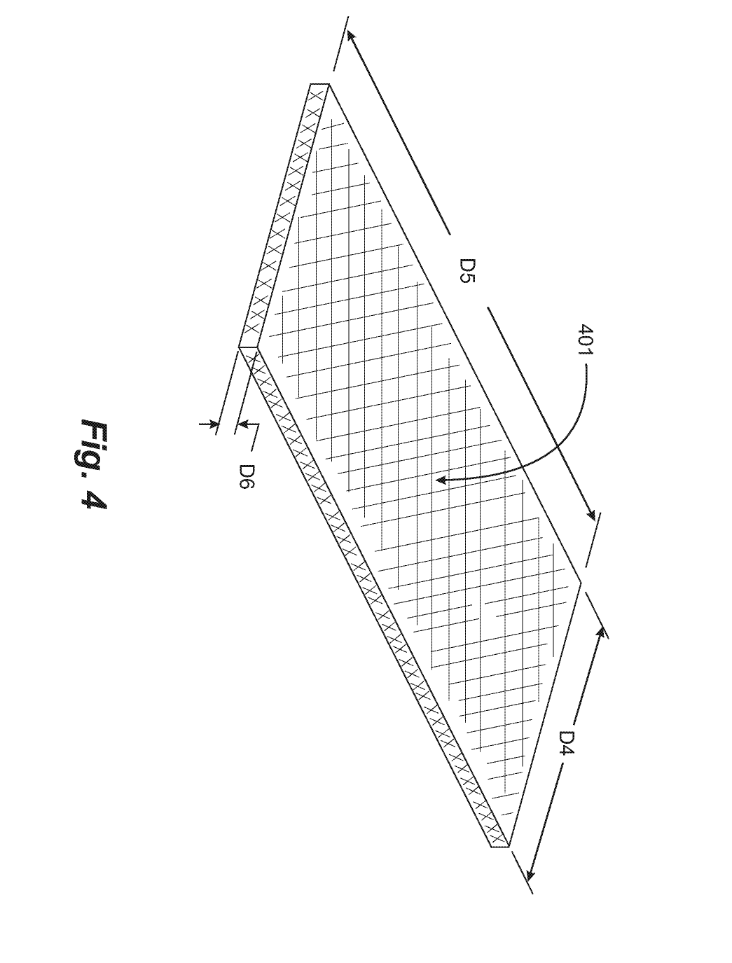

In yet another alternative method as illustrated in FIG. 3A a mold 301 is constructed with an internal volume of a width D1 and length D2 equal to the internal dimensions of frame 101 between the cap and base beams and studs 104 and 105. A depth D3 of the mold is greater than the depth of the frame 101, perhaps in some cases as much as twice or more. FIG. 3B illustrates a ram 303 of width D1 and length D2 trimmed to fit into mold 301. In practice straw is chopped and mixed with a binder material and mold 301 is filled to the top (depth D3) with the treated chopped straw. Ram 303 is placed over the chopped straw in the mold and urged downward by forces F. The treated chopped straw in mold 301 is compressed until the thickness of the mass of straw in the mold is the depth of frame 101, that is, the width of 2 x 6 lumber. The chopped straw in the mold is held at the compressed thickness until the binder cures, and the ram may be removed. The mold may then be disassembled or upturned to remove the compressed straw, which, by virtue of the cured binder, may form a semi-rigid, self-supporting block. In some cases reinforcement such as one or more wooden rods laid lengthwise in the mold may be included to help the released straw block to maintain the shape.

In practice straw blocks may be manufactured as described above and stored until needed in the manufacture of building panels according to embodiments of the invention. Such straw blocks may be moved and stored between plywood panels. Building panels are constructed up to the point of adding the rainscreen strips and the chase strips, and straw blocks manufactured as described above may be placed into the side-by-side volumes in the frames of the panels, then the rainscreen strips and chase strips may be added to complete the panels. In this example the chase strips may be enough restraint to hold the straw blocks in place.

There may be in embodiments of the invention a variety of methods and processes employed. In assembly of structural panels in embodiments of the invention traditional, that is conventional, framing methods of nailing and screwing in a factory setting may be practiced. Assembly line methods may also be used with automated machines.

Processes to be performed either manually or by machines may include:
Moving material from stacks to be processed
Cutting material to size
Nailing/screwing framing together
Nailing/screwing sheathing onto framing
Handling panels (flipping over, standing upright, etc.)
Moving panel down the assembly line to different stations
Adding straw to cavity
Sandwiching the panel between temporary rigid plates to resist bulging forces during insulation densification, vertically filling with straw, removing plates

Processes in straw installation may include:
Compressing horizontal layers with a hydraulic or pneumatic press
Compressing vertical layers with a hydraulic or pneumatic press
Blowing insulation matrix into panel volumes
Filling the panel and using vibratory consolidation either via an internal vibrating tamper (similar to concrete) or external vibration of the panel

Straw installation density is likely to be in the range of 6 pcf - 14 pcf.

In one embodiment of the invention the binder is of choice is specifically a protein: gluten. There are other biobased protein binders such as, for example corn zein, soy protein, whey, and casein, to name just a few. These are the most readily available and also the most studied. In alternative embodiments of the invention one or another of these alternative protein binders may well be used.

Generally speaking, relative to protein binders, proteins have a unique structural form which enables a wide range of functional properties, in particular a high intermolecular binding potential. Proteins generally unfold and dissociate in subunits when treated with heat, acid, base and/or various solvents. Once unfolded, protein chains may interact through hydrogen, ionic, hydrophobic and covalent bonding. Bonding formation is affected by the degree of denaturation and the nature and concentration of amino acids able to form those bonds.

Utilizing a protein material as a binder generally involves denaturing the protein and then facilitating crosslinking of a protein network within the matrix material. Additives that facilitate protein unfolding and subsequent crosslinking vary from protein to protein and depend upon the properties desired. This is particularly true in the case of gluten.

Solvents useful to prepare protein film-forming solutions are generally based on water, alcohol or mixture of water and alcohol or a mixture of other solvents. Most commonly, after mixing and application, solvent removal is generally achieved by hot air or a combination of techniques as it may lead to a differential protein structuring and therefore variable protein film properties.

In an aqueous alcohol solution, gluten can be cross-linked using several methods, including chemical cross-linkers, enzymes, and thermal treatment. These approaches create covalent bonds that alter the protein's structure, which typically increase strength and resistance to water.

Chemical cross-linking incorporates chemical agents to form new bonds between the functional groups of the gluten proteins. Water-soluble carbodiimides, such as 1-ethyl-3-(3-dimethylaminopropyl) carbodiimide HCl (EDC), can form cross-links by coupling carboxyl groups with amino groups on the gluten proteins. The efficiency of this reaction is dependent on pH, with a neutral pH (5–7) favoring intermolecular cross-linking. Addition of N-hydroxysuccinimide (NHS) can also enhance the cross-linking process. Dialdehydes like glutaraldehyde can react with amino groups on the gluten proteins to form strong, covalent bonds. Isophorone diisocyanate may be used to cross-link gluten proteins dissolved in ethanol, significantly improving the resulting material's mechanical strength.

Enzymes may also be used to precipitate cross-linking gluten, particularly in food applications, and may also be used in an alcohol-based solution. The enzyme Transglutaminase catalyzes formation of new bonds between the amino acid lysine and glutamine residues, creating strong, intermolecular bonds. Further, enzymes like sulfhydryl oxidase, laccase, and glucose oxidase promote formation of disulfide bonds (S-S) by oxidizing free sulfhydryl (thiol) groups (SH) on cysteine amino acids. They can also cause other reactions, such as the formation of dityrosine bonds.

In addition to the above, thermal treatment at relatively high temperature may induce cross-linking, especially with addition of other agents like alkali.

Heating an aqueous alcohol solution of gluten can cause the proteins to denature and unfold, exposing hydrophobic groups and sulfhydryl groups. This circumstance promotes formation of new disulfide bonds and other aggregates through hydrophobic interactions. Increasing pH (such as by adding alkali) can lower the temperature required for heat-induced aggregation and strengthen the gluten network.

When working with gluten in aqueous alcohol, only the alcohol-soluble gliadin proteins and reduced glutenin subunits may be fully dissolved. The overall extent and mechanism of cross-linking will depend in part on the ratio of water to alcohol. Increasing concentration of ethanol in the solution can inhibit some types of heat-induced cross-linking, as it affects the protein's conformation and solvent interactions.

A Specific process in the present invention comprises firstly preparing the straw. The straw may be any one of a number of plant-based fibers as described above, such as wheat, rice, barley or oat straw. Other types of plant-based fiber may also be used.

The straw is chopped to an optimal length range and proportion of different fiber lengths, ranging primarily from 2 inches down to 1/8 inch in length. Dust and microparticles may removed if necessary, depending on the batch of straw. In some embodiments a micro-abrasion process may be applied to the surface of the fiber to increase receptivity to binder.

To prepare the binder, gluten within a target protein content range is mixed with warm water. The temperature range may vary. The mixing is accomplished with a blending apparatus converting the gluten material into an aqueous slurry. Soon after preparing the slurry a catalyst or cross-linking agent is added. There are many candidates, such as certain enzymes like Transglutaminase. This enzyme creates strong, covalent bonds that cross-link gluten proteins. Glucose Oxidase operates by catalyzing formation of hydrogen peroxide, creating new disulfide bonds between gluten proteins. Several other enzymes may also be used also cross-link gluten proteins. These include Lactase which cross-links ferulic acid and tyrosine residues on proteins, Peroxidase, similar to glucose oxidase, which uses hydrogen peroxide to form cross-links, Lipoxygenase, which oxidizes lipids, which in turn causes the oxidation of proteins and the formation of cross-links, Ascorbic Acid, which promotes formation of disulfide bonds, which strengthens the gluten network.

After preparation as described above, the binder with the catalyst of cross-linking agent is added to the chopped fiber and mixed, or the chopped fiber may be added to a mixture of water, binder and catalyst, forming a slurry, and the chopped fiber with activated gluten binder may be added to whatever framed structure meant to be insulated by the fiber matrix. This process is, of course, time sensitive, as taking too much time may result in a bonded fiber not malleable enough to add to the framed structure. Finally, heat and airflow is incorporated in encouraging the bonded fiber matrix to solidify, that is, set.

In yet another embodiment of the invention rigid, semi-rigid or flexible insulative panels are prepared, packaged and offered for sale in sizes thought to be useful to builders and contractors to insulate structures in development of homes and buildings.

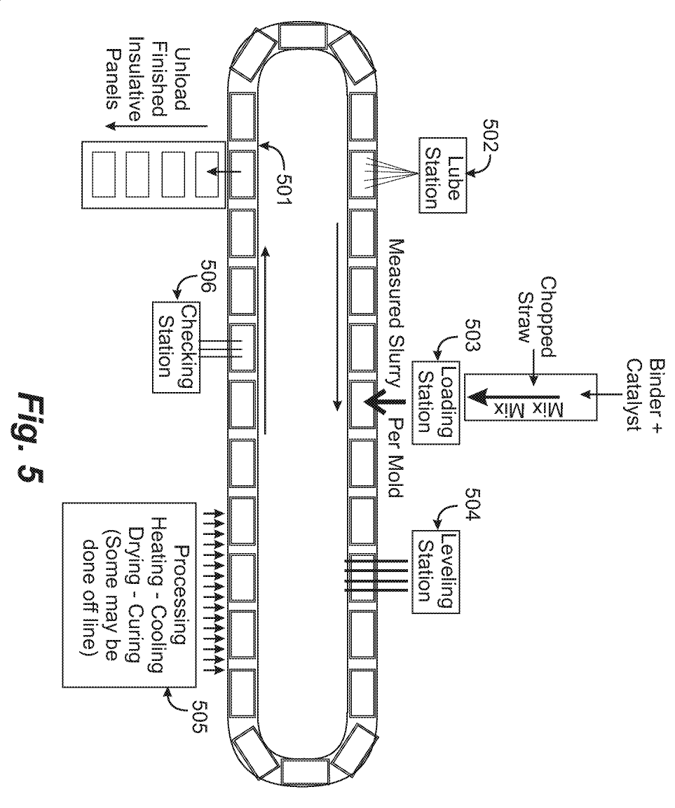

FIG. 4 is a perspective view of an insulative panel 401 having a width D4, a length D5 and a thickness D6. This panel is prepared in one embodiment from plant matter chopped to a specific size range with the chopped plant matter held together by a binder material that provides a rigid mass that may be self-supportive. Further enabling description of the panel material and method of making the panel is provided below.

In one embodiment panel 401 has dimensions D4 = 4 ft., D5 = 8 ft. and D6 = 3.5 inches. 3.5 inches is the width of a 2 x 4 board. A panel of these dimensions may be sawed into four strips 16 inches wide or two strips 24 inches wide which may be placed between wall studs in construction, as 16 inches and 24 inches are a standard spacing between studs and 3.5 inches matches 2 x 4 studs. Depth D6 may be other dimensions to match other lumber dimensions as well. Panel 401 in this example, with binder fully cured may be sawed with conventional saws.

In other embodiments the dimensions of panel 401 may be such as to configure the panel for other purposes. For example, panels 401 may be provided in thicknesses ((D6) of 5 ½ inches for use between ceiling joists of 2 x 6 lumber, 7 ¼ inches for 2 x 8 joists, or 9 ¼ inches for 2 x 10 joists.

In one embodiment panels 401 may be faced on one or both sides with paper or fabric. Paper facing may be, for example, kraft paper, which is primarily made from wood pulp, specifically long softwood fibers like pine, spruce, and fir. Kraft paper is produced using a process in which wood chips are cooked in a mixture of water, sodium hydroxide, and sodium sulfide to break down lignin, leaving behind strong, cellulose-rich fibers. Fabric facing may be of cotton, hemp, jute, flax, abaca, pia, ramie, sisal, bagasse, or banana, which are all fabrics of vegetable fibers based on cellulose arrangements.

One method for making panel 401 may follow the description above of FIG. 3A and 3B. Chopped straw may be mixed with a binder material and may be placed in a mold such as the mold illustrated in FIG. 3A, and either pressed or leveled to thickness, then left for the binder to cure. In some circumstances, depending on nature of the binder material, heat or addition of a catalyst material may be employed to precipitate or enhance the binding process. Once the binding is complete the panel may be removed and the mold perhaps cleaned, and then reused to form another panel.

In some embodiments the binder may be nanocellulose or sugar or starch-based material. Natural waxes may also be used as binders. After filling the mold the binder material may harden by a chemical or a physical process and cause the chopped straw to form a semi-solid form. In some cases the binder may be liquid at a temperature at application and may gel on cooling. In this circumstance cool air may be used to enhance binding.

There are a wide variety of materials that might be used as a binder. Some are polymeric. Other chemical fillers may be used as well. Naturally derived admixtures are preferably used. In some circumstances chopped straw with a binder may be used and a fabric netting or screen may be employed as well.

Straw might in some embodiments be long strand. In other embodiments the straw may be chopped to specific parameters that denote both a gradient and proportion of straw fiber sizes, for example from roughly 12” in length down to roughly 1/32 inches in length. The chopped straw may be cleaned to remove small straw particles by graded screening and by moving air over the straw to remove fines and dust. In some cases a binder may be heated before being added to straw particles, and in some processes the straw particles may be heated without a binder. In some processes industrial agricultural machinery may be used in the processing of straw. An important feature of the processing a straw with or without a binder is to create a straw matrix with a microstructure that significantly improves upon the thermal performance of unprocessed straw.

In the general molding process described above, once a panel is removed from a mold, the panel may be faced with paper or fabric on one or both sides, as described above. Finished panels may be warehoused for future sale. A plurality of molds may be employed in parallel process to increase production rate. In one variation of production molds may be moved along a conveyance in a production line. In this embodiment there may be a moving production of chopping straw and adding binder to the straw as well, such that chopped straw with binder may arrive at a loading point along the mold line where molds are filled in passing. There may be, as needed, stations for heating, or for cooling after molds are filled, and a station for panel removal and empty molds may be cleaned and returned to a head of the production line. Ther may be a station for spraying molds with a lubricant material to avoid adherence to the panel material. Production planning may require a plurality of production lines to meet manufacturing quotas.

In one embodiment of the invention the binder of choice is a protein, and in one embodiment specifically gluten. This description is taken from previous pages of this specification and repeated here, as applied in mass production of insulative panels.

There are other biobased protein binders such as, for example corn zein, soy protein, whey, and casein, to name just a few. These are the most readily available and also the most studied. In alternative embodiments of the invention one or another of these alternative protein binders may well be used.

Generally speaking, relative to protein binders, proteins have a unique structural form which enables a wide range of functional properties, in particular a high intermolecular binding potential. Proteins generally unfold and dissociate in subunits when treated with heat, acid, base and/or various solvents. Once unfolded, protein chains may interact through hydrogen, ionic, hydrophobic and covalent bonding. Bonding formation is affected by the degree of denaturation and the nature and concentration of amino acids able to form those bonds.

Utilizing a protein material as a binder generally involves denaturing the protein, and then facilitating crosslinking of a protein network within the matrix material. Additives that facilitate protein unfolding and subsequent crosslinking vary from protein to protein and depend upon the properties desired. This is particularly true in the case of gluten.

Solvents useful to prepare protein film-forming solutions are generally based on water, alcohol or mixture of water and alcohol or a mixture of other solvents. Most commonly, after mixing and application, solvent removal is generally achieved by hot air or a combination of techniques as it may lead to a differential protein structuring and therefore variable protein film properties.

In an aqueous alcohol solution, gluten can be cross-linked using several methods, including chemical cross-linkers, enzymes, and thermal treatment. These approaches create covalent bonds that alter the protein's structure, which typically increase strength and resistance to water.

Chemical cross-linking incorporates chemical agents to form new bonds between the functional groups of the gluten proteins. Water-soluble carbodiimides, such as 1-ethyl-3-(3-dimethylaminopropyl) carbodiimide HCl (EDC), can form cross-links by coupling carboxyl groups with amino groups on the gluten proteins. The efficiency of this reaction is dependent on pH, with a neutral pH (5–7) favoring intermolecular cross-linking. Addition of N-hydroxysuccinimide (NHS) can also enhance the cross-linking process. Dialdehydes like glutaraldehyde can react with amino groups on the gluten proteins to form strong, covalent bonds. Isophorone diisocyanate may be used to cross-link gluten proteins dissolved in ethanol, significantly improving the resulting material's mechanical strength.

Enzymes may also be used to precipitate cross-linking gluten, particularly in food applications, and may also be used in an alcohol-based solution. The enzyme Transglutaminase catalyzes formation of new bonds between the amino acid lysine and glutamine residues, creating strong, intermolecular bonds. Further, enzymes like sulfhydryl oxidase, laccase, and glucose oxidase promote formation of disulfide bonds (S-S) by oxidizing free sulfhydryl (thiol) groups (SH) on cysteine amino acids. They can also cause other reactions, such as the formation of dityrosine bonds.

In addition to the above, thermal treatment at relatively high temperature may induce cross-linking, especially with addition of other agents like alkali.

Heating an aqueous alcohol solution of gluten can cause the proteins to denature and unfold, exposing hydrophobic groups and sulfhydryl groups. This circumstance promotes formation of new disulfide bonds and other aggregates through hydrophobic interactions. Increasing pH (such as by adding alkali) can lower the temperature required for heat-induced aggregation and strengthen the gluten network.

When working with gluten in aqueous alcohol, only the alcohol-soluble gliadin proteins and reduced glutenin subunits may be fully dissolved. The overall extent and mechanism of cross-linking will depend in part on the ratio of water to alcohol. Increasing concentration of ethanol in the solution can inhibit some types of heat-induced cross-linking, as it affects the protein's conformation and solvent interactions.

A Specific process in the present invention comprises firstly preparing the straw. The straw may be any one of a number of plant-based fibers as described above, such as wheat, rice, barley or oat straw. Other types of plant-based fiber may also be used.

The straw is chopped to an optimal length range and proportion of different fiber lengths, ranging primarily from 3 inches down to 1/8 inch in length. In another embodiment the length constraint may be from 1/8 to 2 inches. Dust and microparticles may be removed if necessary, depending on the batch of straw. In some embodiments a micro-abrasion process may be applied to the surface of the fiber to increase receptivity to binder.

To prepare the binder, gluten within a target protein content range is mixed with warm water. The temperature range may vary. The mixing is accomplished with a blending apparatus converting the gluten material into an aqueous slurry. Soon after preparing the slurry a catalyst or cross-linking agent is added. There are many candidates, such as certain enzymes like Transglutaminase. This enzyme creates strong, covalent bonds that cross-link gluten proteins. Glucose Oxidase operates by catalyzing formation of hydrogen peroxide, creating new disulfide bonds between gluten proteins. Several other enzymes may also be used also cross-link gluten proteins. These include Lactase which cross-links ferulic acid and tyrosine residues on proteins, Peroxidase, similar to glucose oxidase, which uses hydrogen peroxide to form cross-links, Lipoxygenase, which oxidizes lipids, which in turn causes the oxidation of proteins and the formation of cross-links, Ascorbic Acid, which promotes formation of disulfide bonds, which strengthens the gluten network.

After preparation as described above, the binder with the catalyst of cross-linking agent is added to the chopped fiber and mixed, and the chopped fiber with activated gluten binder may be added to the molds, one-by-one, in a linear production process This process is, of course, time sensitive. Finally, heat and airflow may be incorporated in encouraging the bonded fiber matrix to solidify, that is, set.

Binding in these circumstances is not instantaneous and occurs over a period that allows ample time to mix the chopped straw with the prepared gluten binder, add any enzymes or other activating agent, and to flow the resulting slurry into passing molds. The timing for production may be controlled by choices of binding material, catalysts, and heating and cooling temperatures.

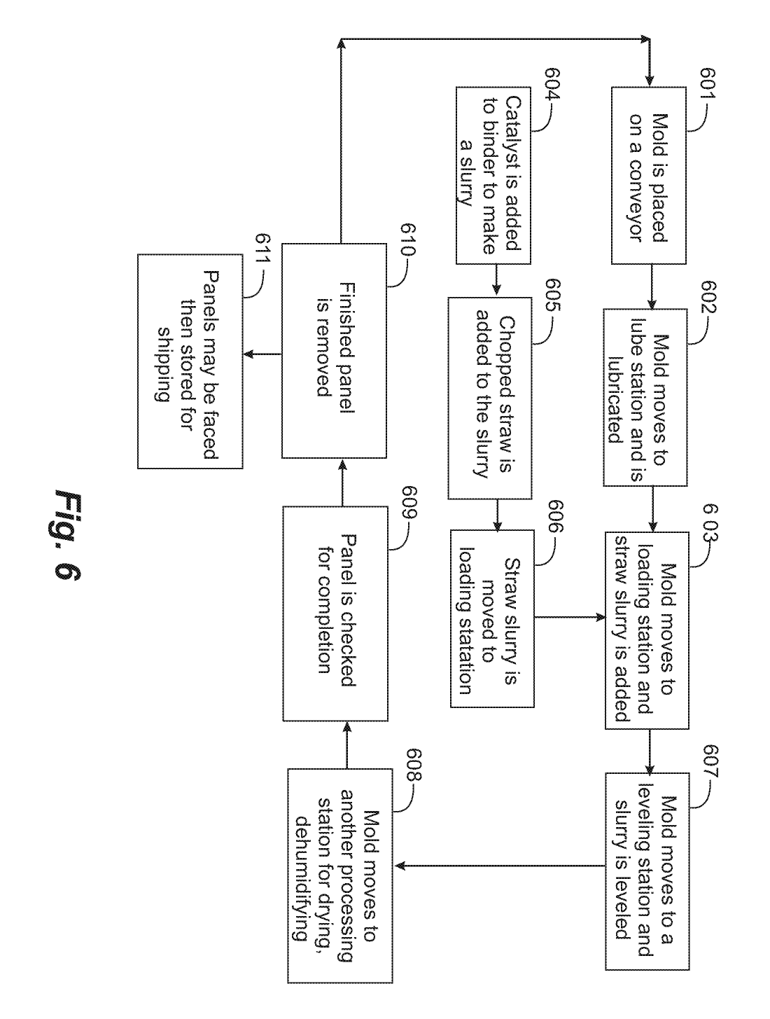

FIG. 5 is a mostly representative plan view of a conveyor process for making insulative panels. A conveyor 500 is a closed conveyor, meaning it operates in a loop, always returning to a starting point. In this embodiment the conveyor carries molds 501 for casting insulative panels according to embodiments of the present invention. In this example molds 501 may be placed on the conveyor and removed and may be spaced by physical elements on the conveyor, The conveyor in this example moves clockwise as indicated.

At a Lube Station 502 empty molds 501 may be sprayed or otherwise coated with oil or other release agent to avoid adherence of panel material to the molds. In one embodiment the conveyor moves intermittently to stop after moving one mold distance. A loading station 503 is configured to load a measured amount of a slurry of a binder mixed with a curing catalyst, after which chopped straw is added and the straw slurry is loaded into the mold stopped at the load station. A process of receiving binder with catalyst and mixing in chopped straw is shown feeding the loading station. As the conveyor indexes a loaded mold stops at a leveling station where the slurry in the mold may be manipulated to properly fill the mold.

The conveyor continues to index and filled molds reach a processing region 505 where molds and slurry may be processed by heating, cooling, drying or curing, or otherwise treated as needed. In some embodiments some of these functions may be accomplished offline, due to time constraints. Panels are checked at a checking station 506 to determine if the binder is properly set and panels may be removed. Finished panels are removed at an unload station 507 and may be transported for storage and later sale.

FIG. 6 is a flow diagram illustrating the process shown in FIG. 5 in production of insulative panels. At step 601 a mold is on a conveyor ahead of filling or processing. At step 602 the mold moves on the conveyance to an optional lubrication station and is coated with an oil or other release agent to prevent adhesion of panel material to mold surfaces. At step 603 the mold moves on the conveyance to a loading station where straw slurry with binder and optional catalysts may be added to the mold.

In a separate but parallel process, at step 604 a catalyst is added to a binder to make a slurry. At step 605 chopped straw is added to the slurry, forming a straw slurry. At step 606 the straw slurry is moved to the loading station along the mold conveyance, where a measured amount of the straw slurry is added to a mold as the mold stops at the loading station.

At step 607 the loaded mold moves to a leveling station and the straw slurry in the mold is leveled for the height of the mold. At step 608 the loaded and leveled mold moves to another processing station where heating, cooling, drying and curing may be accomplished. In some circumstances some processing may be done off-line due to time constraints. At step 609 the panel in the mold is checked for completion. That is, to see if the binder has set and the panel is ready to be removed from the mold. At step 610 the finished panel is removed from the mold, and the mold moves back to the head of the conveyance at step 601.

At step 611, not indicated in FIG. 5, panels may be faced with paper or fabric, on one side or both, and may be stacked and stored for later sale. Facing in some circumstances may be done at one or more processing stations on the conveyor line. The skilled person will understand that the process described may be accomplished in another order, and that other processing steps may be added or duplicated at stations along the conveyance.

The skilled person will understand that molds may be conveyed in the process that have different dimensions, or all molds may be dedicated to panels of one size.

The skilled person will understand that the order and timing of steps in the process may be varied somewhat in practice. Further, the skilled person will be aware that the embodiments described above, both methods and apparatus, are entirely exemplary, and are not limiting to the scope of the invention. There are a wide range of variations that might be made within the scope of the invention, which is limited only by the claims.

1. An insulative panel having a width, a length and a thickness, comprising:
plant matter chopped into pieces having a specific size range; and
a binder holding the chopped pieces together in a rigid mass.

2. The insulative panel of claim 1 wherein the width is four feet, the length is eight feet and the thickness is one of 3 ½ inches, 5 ½ inches, 7 ¼ inches, or 9 ¼ inches.

3. The insulative panel of claim 1 wherein the plant matter is one of or a mixture of wheat, rice, barley or oat straw, chopped into pieces from one eighth to 2 inches in length.

4. The insulative panel of claim 1 wherein the binder is one of nanocellulose, sugar, starch-based material or one or a mixture of natural waxes.

5. The insulative panel of claim 1 wherein the binder is a plant protein.

6. The insulative panel of claim 5 wherein the protein is gluten.

7. A method for making an insulative panel, comprising:
providing a mold of a width, a length and a depth;
filling the mold with a slurry of chopped straw mixed with a binder;
allowing time for the binder to solidify; and
removing the insulative panel from the mold.

8. The method of claim 6 further providing coating the mold with a release agent prior to the step of filling the mold.

9. The method of claim 6 comprising filling the mold with a slurry of chopped straw of one of or a mixture of wheat, rice, barley or oat straw, chopped into pieces from one eighth to 2 inches in length, mixed with gluten as the binder.

10. The method of claim 9 comprising mixing gluten with warm water to form the slurry, and adding a catalyst to the slurry, prior to filling the mold.

11. The method of claim 10 comprising selecting the catalyst as an enzyme.

12. The method of claim 11 comprising selecting transglutaminase as the enzyme.

13. A method of making insulative panels, comprising:
providing a closed conveyance with molds evenly spaced apart along the conveyance;
indexing the conveyance intermittently a length of the spacing between molds on the conveyance;
adding a measured amount of a slurry of chopped straw mixed with a binder to each mold stopped at a loading station; and
removing insulative panels from molds stopped at an unloading station.

14. The method of claim 13 further comprising leveling the slurry in molds stopped at a leveling station after the loading station.

15. The method of claim 13 further comprising, in the step for adding a measured amount of a slurry of chopped straw mixed with a binder, providing the chopped straw as one of or a mixture of wheat, rice, barley or oat straw, chopped into pieces from one eighth to 2 inches in length, mixed with gluten as the binder.

16. The method of claim 15 comprising mixing gluten with warm water and a catalyst, then adding chopped straw to form the slurry, prior to filling the mold.

17. The method of claim 16 comprising providing the catalyst as an enzyme.

18. The method of claim 17 comprising selecting transglutaminase as the enzyme.

19. The method of claim 18 comprising providing heat or cooling to slurry loaded molds at one or more stations.

20. The method of claim 19 comprising coating empty molds with a release agent prior to the step of filling the molds with the slurry of chopped straw mixed with a binder.
